(19) United States
(12) Patent Application Publication
(10) Pub. No.: US 2013/0246018 A1
(43) Pub. Date: Sep. 19, 2013

(54) METHOD OF SYNTHESIZING AND ANALYZING THERMALLY ACTUATED LATTICE ARCHITECTURES AND MATERIALS USING FREEDOM AND CONSTRAINT TOPOLOGIES

(71) Applicants: Christopher Spadaccini, Oakland, CA (US); Jonathan Hopkins, Livermore, CA (US)

(72) Inventors: Christopher Spadaccini, Oakland, CA (US); Jonathan Hopkins, Livermore, CA (US)

(73) Assignee: Lawrence Livermore National Security, LLC, Livermore, CA (US)

(21) Appl. No.: 13/607,644

(22) Filed: Sep. 7, 2012

Related U.S. Application Data
(60) Provisional application No. 61/532,071, filed on Sep. 7, 2011.

(51) Int. Cl. G06F 17/50

(52) U.S. Cl. CPC G06F 17/5009
USPC 703/2; 703/6

(57) ABSTRACT

A method using freedom and constraint topologies to synthesize and analyze the microstructure of a material with a desired thermal expansion coefficient. The method includes identifying tab kinematics of a design space sector that will produce a desired bulk material property, selecting a freedom space that contains a desired tab motion identified from the tab kinematics identified, selecting flexible constraint elements from within a complementary constraint space of the freedom space selected, and selecting actuation elements from within an actuation space generated from a system generated from the flexible constraint element selection.

### CROSS-REFERENCE TO RELATED APPLICATIONS

This patent document claims the benefits and priorities of U.S. Provisional Application No. 61/532,071, filed on Sep. 7, 2011, hereby incorporated by reference.

### FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC for the operation of Lawrence Livermore National Laboratory.

### TECHNICAL FIELD

This patent document relates to methods of synthesizing structural architectures having designed thermal performance, and in particular to a method of synthesizing and analyzing thermally actuated lattice architectures and materials using freedom and constraint topologies (FACT).

### BACKGROUND

Various methods of synthesizing microstructural architectures that achieve superior thermal properties from those of naturally occurring materials are known. One common synthesis approach for designing the microstructure of materials is topological synthesis for numerically generating microstructural architecture designs. In particular, topology optimization utilizes a computer to iteratively construct a microstructural architecture that possesses properties, which most closely approach the desired target properties while satisfying specific constraint functions. The design space begins with an unorganized mixture of desired materials and a cost function is minimized until an optimal microstructural architecture is achieved, which consists of organized clumps of the materials. For example, a computer can iteratively construct the topology of flexible structures by satisfying input and output displacement and force specifications using systems of linear beam elements.

Unfortunately, because this process is computer driven, the designer has no influence on what's being designed. And since the computers don't take certain things into account such as motion visualization, pattern recognition, and common sense, most of the concepts generated using Topological Synthesis may not be practical for implementation, adaptation, or fabrication. One of the biggest problems with topology optimization is that designer can never be certain that the most optimal concept was identified. The cost function often bottoms out inside a local minimum instead of the global minimum, which corresponds to the truly optimal microstructural architecture. Furthermore, it is difficult to know which constraint functions to impose on the optimization, as vastly different concepts are generated depending on the constraint functions that are applied. Often, the computer generates microstructural architectures that possess impractical features, which are not possible to fabricate or implement. The reason for this deficiency is that the computer is not able to apply commonsense or creativity during the optimization process to recognize or generate functional concepts with practical features.

In addition to synthesizing methods, various analytical methods exist for determining the material properties of synthesized microstructures. Topological synthesis may be used as well as computer aided design FEA (finite element analysis) packages. Various FEA packages exist that utilizes a variety of approaches. One approach is the matrix method. This approach is used for the analysis of trusses where each beam is used as a single element.

### SUMMARY

In one example implementation, a method is provided for synthesizing and analyzing the microstructure of a material with a desired thermal expansion coefficient comprising: identifying tab kinematics of a design space sector that will produce a desired bulk material property; selecting a freedom space that contains a desired tab motion identified from the tab kinematics identified; selecting flexible constraint elements from within a complementary constraint space of the freedom space selected; and selecting actuation elements from within an actuation space generated from a system generated from the flexible constraint element selection.

In another example implementation, a method is provided for synthesizing and analyzing the microstructure of a material with a desired thermal expansion coefficient comprising: designing a rigid stage and ground points; determining the desired motion of the rigid stage according to the nature of the thermal expansion coefficient; finding an appropriate freedom space from the FACT chart that contains this motion; selecting flexure bearings from the complementary constraint space of the selected Freedom Space using sub-constraint spaces; calculating the actuation space of the bearing set; and selecting the appropriate number of constraints from the actuation space that fully constrain the stage and will produce a net resultant force on the stage to actuate it to move with the desired motion.

These and other implementations and various features and operations are described in greater detail in the drawings, the description and the claims.

The present invention is generally directed to a method for synthesizing and analyzing the structure of lattice-based architectures and materials, including microstructural architectures, which possess bulk thermal properties that are advantageous to those currently achieved by composites, alloys, and other naturally occurring materials. This approach utilizes and extends the principles of the Freedom and Constraint Topologies (FACT) flexure design process for synthesizing parallel flexure system concepts to enable the generation of thermally actuated materials for almost any application, and in particular that may be combined to create cellular modules that form the microstructures of new materials that possess extreme or unnatural thermal expansion properties, e.g., large negative thermal expansion coefficients and Poisson's Ratios. The FACT flexure design process described in (a) Hopkins J B, Culpepper M L. Synthesis of multi-degree of freedom, parallel flexure system concepts via freedom and constraint topology (FACT)—Part I: Principles. Precis Eng 2010; 34:259-270; (b) Hopkins J B, Culpepper M L, Synthesis of multi-degree of freedom, parallel flexure system concepts via freedom and constraint topology (FACT)—Part II: Practice. Precis Eng 2010; 34:271-278; (c) Hopkins J B, Culpepper M L, Synthesis of precision serial flexure systems using freedom and constraint topologies (FACT), Precis Eng 2011 PRE-D-10-00136R2; (d) Hopkins J B. Design of flexure-based motion stages for mechatronic systems via freedom, actuation and constraint topologies (FACT). PhD Thesis. Massachusetts Institute of Technology; 2010; and (e) Hopkins J B. Design of parallel flexure systems via freedom and constraint topologies (FACT). Masters Thesis. Massachusetts Institute of Technology; 2007, are incorporated by reference herein.

For the synthesis of these microstructure modules, FACT provides a comprehensive library of geometric shapes, which may be used to visualize the regions wherein various microstructural elements can be placed for achieving desired bulk material properties. In this way, designers can rapidly consider and compare every microstructural concept that best satisfies the design requirements before selecting the final design. The rules for navigating through these shapes differ depending on what properties are desired. While FACT was originally developed and applied to the synthesis of precision flexure systems, the present invention extends and applies FACT for the design of microstructures that possess desired material properties. Using FACT designers may consider every parallel flexure concept that may be combined to achieve any material property before finalizing on any one concept. They may apply their common sense and knowledge of the process that will be used to make the material, to synthesize an optimal, practical design that can be fabricated and implemented. Essentially the FACT-based synthesis process of the present invention would be very effective for designing any material with any mechanical property. For example, a material that twists when it is pushed on could be made. Various electrical leads could be placed across the material to excite different responses like shearing, or expanding/contracting, or twisting motions etc. Artificial muscles and novel actuators would be very applicable to this type of design.

Unlike the computer-driven topology optimization processes discussed in the Background, the FACT synthesis process enables designers to utilize geometric shapes to visualize and compare every microstructural concept, which is capable of achieving the desired thermal properties. Designers are able to apply their ability to rapidly identify practical concepts and their knowledge of the process that will be used to fabricate the new material to synthesize the most promising concepts. These concepts could then be fed into topology optimization programs to determine which of the concepts will fall inside the cost function's global minimum. Even without topology optimization programs, however, the concepts may be compared with other metrics to identify the optimal concept, which most closely satisfies the material's bulk property requirements.

And for the analysis of the synthesized microstructures, the present invention also includes a matrix-based approach to rapidly calculate and optimize the desired thermal properties of the microstructural concepts that are generated using FACT. In particular, the analysis method models the struts between each junction as flexible elements, e.g., wire flexures or flexure blades, and the junctions themselves as rigid-bodies. Each strut and junction may be any geometry and made of any material. By utilizing the mathematics of screw theory, the basis of the geometric shapes used by FACT for synthesis, and described in (a) Ball R S. A treatise on the theory of screws. Cambridge, UK: The University Press; 1900; (b) Phillips J. Freedom in machinery: volume 1, introducing screw theory. New York, N.Y.: Cambridge University Press; 1984; (c) Phillips J. Freedom in machinery: volume 2, screw theory exemplified. New York, N.Y.: Cambridge University Press; 1990; (d) Bothema R, Roth B. Theoretical kinematics. Dover, 1990; (e) Hunt KH. Kinematic geometry of mechanisms. Oxford, UK: Clarendon Press; 1978; and (I) Merlet JP. Singular configurations of parallel manipulators and grassmann geometry. Inter J of Robotics Research 1989; 8(5):45-56, incorporated by reference herein, designers may use the analysis approach to calculate the resulting motions of any of the rigid junctions for any force, moment, or temperature loads on any of the struts. Using this information, the desired bulk material properties may be determined. Large sections are also modeled as nodes and model various flexible elements of any geometry as truss elements. In this way, method of the present invention is generalized and may be applied to more structures than just trusses. This approach can be faster and more accurate than FEA packages that mesh the entire microstructure.

The analysis approach could be implemented, for example, in a software package for quickly and accurately analyzing very complex structures that would cause most FEA (Finite Element Analysis) packages to fail. The meshing and computational power necessary to analyze these types of microstructures using traditional FEA packages does not exist. This approach requires much fewer calculations and would be much more accurate for small motion approximations (Small motion calculations are all that is required to measure the bulk material's properties). In essence, we have developed a screw-theory based analysis package that is suited for the analysis of complex microstructures. The analytical nature of this tool enables it to optimize concepts within fractions of a second, whereas topology optimization often requires tens of hours to converge to an optimal solution. The accuracy of this analytical tool is verified at the end of this paper using a sophisticated FEA tool called ALE3D.

### BRIEF DESCRIPTION OF THE DRAWINGS

FIGS. 1A and 1B show 2D microstructural architecture designs that consists of unit cells made up of triangular sectors.

FIG. 1C show the sectors of FIGS. 1A-B

FIG. 1D shows the geometric shapes of FACT used to design the sectors of FIG. 1C.

FIG. 2A-C show a parallel flexure system's three DOFs

FIG. 2D shows the freedom space of the parallel flexure system of FIGS. 2A-C.

FIG. 3A shows an exemplary system's complementary freedom and constraint space pair.

FIG. 3B shows the flexible constraints of FIG. 3A lie within the system's constraint space.

FIG. 4A show an exemplary system's actuation space.

FIG. 4B shows the selection of thermally actuated constraints from within the actuation space.

FIG. 4C shows the how selectively heating each thermally actuated constraint by different temperatures causes the stage to move with various combinations of its DOFs (C).

FIG. 5A shows a blank general 2D microstructural architecture for synthesizing thermally actuated materials.

FIG. 5B shows a general design space sector for achieving a material with a negative thermal expansion coefficient.

FIGS. 6A-B show two negative-thermal-expansion sectors with actuation elements that do not lie within the system's actuation space.

FIGS. 6C-D show the unit cells associated with sectors of FIGS. 6A-B, respectively.

FIG. 7A-B shows a sector example with no flexure bearing elements and its unit cell.

FIG. 8 shows parameters necessary to calculate the thermal expansion coefficient of a unit cell, which is modeled as small rigid bodies (shown in black) connected by flexible elements.

FIG. 9 shows parameters and conventions necessary to construct Eq. (3) for a general microstructural architecture.

FIG. 10A shows dimensions for the microstructural architecture.

FIG. 10B shows a mesh of the architecture generated using ALE3D.

FIG. 10C shows a comparison of this architecture's thermal expansion coefficient calculated using FEA verses the analytical tool of this paper.

FIG. 11 shows a flow chart of the an exemplary synthesizing method of the present invention.

FIG. 12 shows a flow chart of the another exemplary synthesizing method of the present invention.

### DETAILED DESCRIPTION

A. Microstructural Architecture

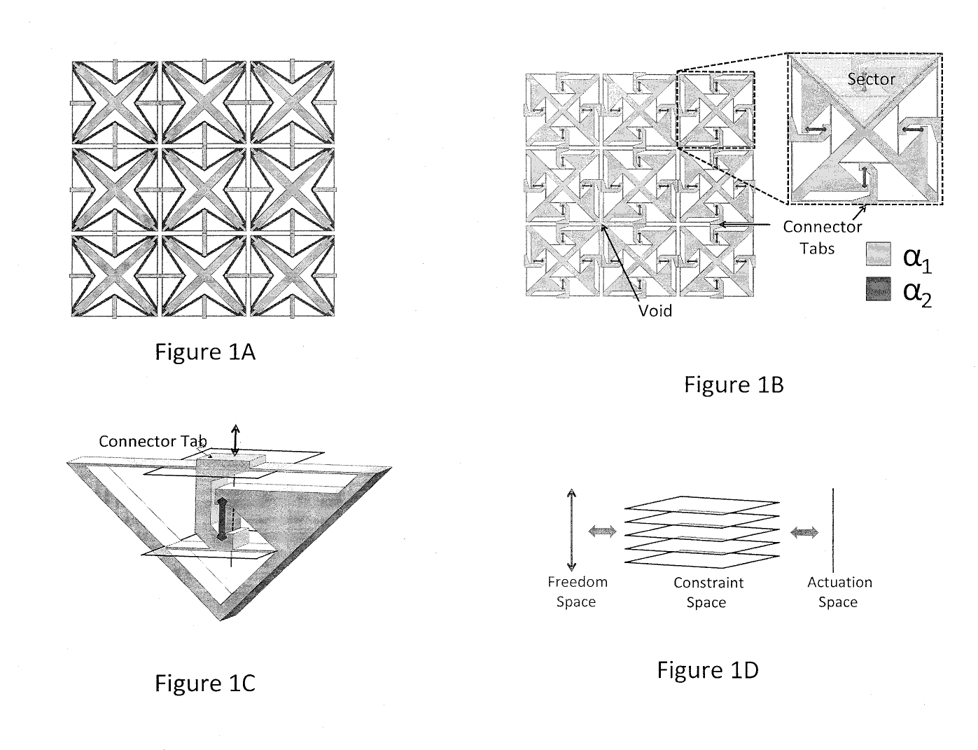

To understand the use and operation of FACT in the present invention, the microstructural architecture shown in FIG. 1B may be considered. This architecture consists of two natural materials each with positive but different thermal expansion coefficients. The material shown in grey in FIG. 1B has a thermal expansion coefficient of α₁ and the material shown in red has a thermal expansion coefficient of α₂. If α₂>α₁ the bulk material will possess a negative thermal expansion coefficient in two dimensions. The reason for this bulk contraction when subjected to an increase in temperature is best understood by considering the geometry of each unit cell within the microstructural architecture. A magnified example unit cell is shown within a dashed square in FIG. 1B. Each unit cell consists of four triangular sectors one of which is highlighted in the figure. Within each sector there is a connector tab that will pull towards the center of the unit cell when heated. The reason for this pulling motion is that the red material will expand more than the grey material thus deforming the flexure blades constraining the tab. Note also that each cell is connected together by the connector tabs. As the temperature increases, the cells expands into the void spaces (one of which is labeled in FIG. 1B) and the connector tabs pull inward causing the entire architecture to contract along the two axes.

The sectors within the unit cells of the microstructural architectures of FIG. 1 were designed using the geometric shapes of the FACT synthesis process. Consider the example sector shown in FIG. 1C and the geometric shapes shown in FIG. 1D used to synthesize the sector. One set of shapes, called freedom spaces, represent the sector's tab motions caused by changes in temperature. In this example, the freedom space is a black double-sided arrow, which represents a translation along its axis. Another set of shapes, called constraint spaces, represent the regions containing the flexure bearing constraint elements that guide the motions of the freedom space. In this case, the constraint space consists of an infinite number of blue parallel planes. Microstructural constraint elements that are selected from within these planes will guide the tab along the axis of the freedom space's translation. Note from FIG. 1C that the four parallel flexure blades are selected from within this constraint space. A final set of shapes, called actuation spaces, represent the regions wherein actuation elements belong that thermally actuate the desired motions. In this case, the actuation space consists of a single blue line that is orthogonal to the parallel planes of the constraint space. This line represents the axis of the actuation element that will cause the tab to translate as temperatures change. Note from FIG. 1C that the axis of the red element is aligned with this blue line.

B. Principles of FACT

The following describes some of the principles of FACT, which are necessary to synthesize thermally actuated microstructural architectures.

### Freedom Space

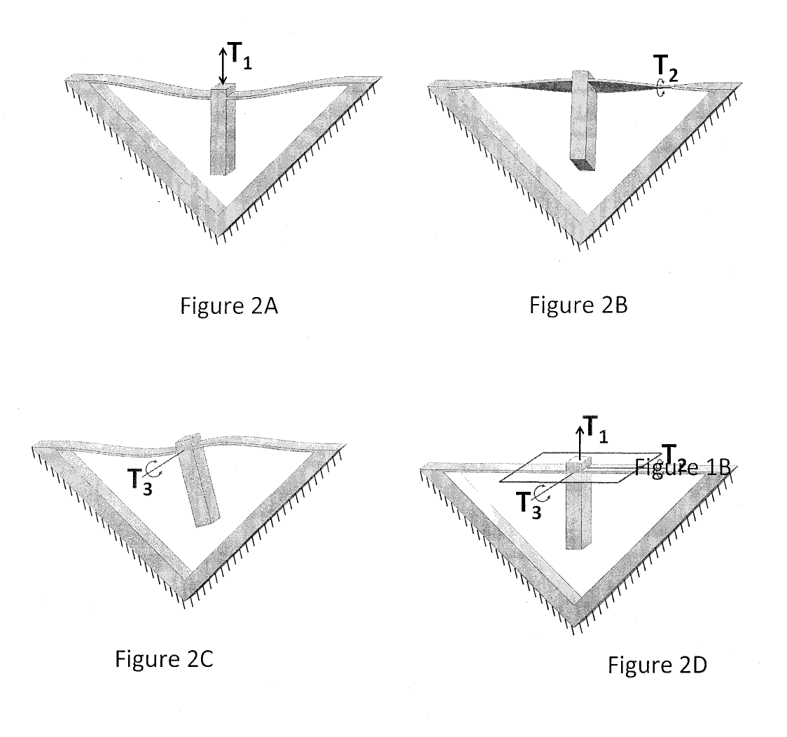

The concept of freedom space may be described in the context of a flexure system shown in FIG. 2. Two coplanar flexure blades constrain a long rectangular stage such that it possesses three degrees of freedom (DOFs)—one translation shown as a double-sided black arrow in FIG. 2A and two rotations shown as red lines with circular arrows about their axes in FIG. 2B-C. Although these three motions represent the system's DOFs, they do not represent all the motions permitted by the flexure blades. If, for instance, all three DOFs were simultaneously actuated with various magnitudes, the stage would appear to rotate about lines that lie on the plane of the flexure blades. This plane of rotation lines and the orthogonal translation arrow shown in FIG. 2D is the system's freedom space. Freedom space is the geometric shape that visually represents the complete kinematics of a flexure system (i.e., all the motions that the system's flexible constraints permit).

According to screw theory, all motions may be modeled using 1×6 vectors called twists, T. Twists, T₁, T₂, and T₃, are used to model the three DOFs of the flexure system shown in FIG. 2. In mathematical terms, a system's freedom space may be generated by linear combination of the twists that model the system's DOFs, and the number of system DOFs is the number of independent twists within that system's freedom space.

### Constraint Space

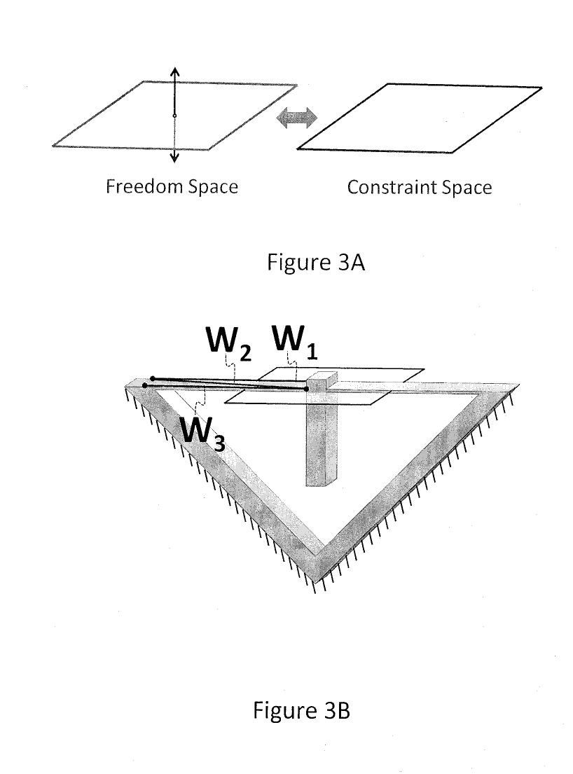

Every freedom space uniquely links to a complementary or reciprocal constraint space. A system's constraint space is a geometric shape, which represents the region wherein flexible constraints may be placed such that the system's stage will possess the DOFs represented by its freedom space. The complementary constraint space of the system from FIG. 2 is shown in FIG. 3A. This constraint space is a plane, which is coplanar with the plane of its freedom space. Note from FIG. 3B that both flexure blades lay on the plane of the constraint space and thus permit the stage's desired DOFs from FIG. 2.

Constraint spaces consist of constraint lines. Constraint lines are depicted in this paper as blue lines that represent forces along their axes. Flexible constraints may be represented by the set of all constraint lines that lie within the geometry of the flexible constraint and directly connect the system's stage to its fixed ground. These lines represent the directions along which the constraint is able to impart restraining forces to prevent the stage from moving. According to screw theory, constraint lines may be modeled using pure-force 1×6 wrench vectors, W. If a system's freedom space possesses n DOFs, its constraint space will consist of m independent wrench vectors where

m=6−n Eq. (1)

This equation stems from the fact that (i) every free-standing object, which is not constrained, possesses 6 DOFs (i.e., three orthogonal rotations and three orthogonal translations) and (ii) independent wrench vectors (i.e., non-redundant constraint lines) each remove a single DOF from the system that they constrain. According to Eq. (1), therefore, the constraint space of the three DOF system of FIG. 2 should consist of three independent wrench vectors. The three blue constraint lines labeled W₁, W₂, and W₃ in FIG. 3B are examples of independent wrench vectors because their constraint lines are not all parallel and do not all intersect at the same point. These constraint lines lie within the geometry of the flexure blade and directly connect the system's stage to its ground. Since this flexure blade is capable of imparting forces on the rectangular stage along the axes of these constraint lines, the stage is restricted to only move with the kinematics represented by its freedom space. Any other wrench vector that represents a constraint line that lies on either flexure blade and connects the stage to the ground will be mathematically dependent and is, therefore, said to be redundant because it does not affect the system's kinematics.

If a designer knows which constraint space uniquely links to the freedom space that represents the desired DOFs, he/she is able to very rapidly visualize every concept within the constraint space that satisfies the desired kinematics. Once the appropriate number of independent constraint lines has been selected from the constraint space according to Eq. (1), any other constraint line selected from the same space will be redundant and will not affect the system's kinematics but will affect its stiffness, load capacity, and dynamic characteristics. Rules for selecting constraint lines from within constraint spaces such that they are non-redundant are provided in (a) Hopkins, J. B., Culpepper, M. L., 2010, “Synthesis of Multi-Degree of Freedom, Parallel Flexure System Concepts via Freedom and Constraint Topology (FACT)—Part II: Practice,” Precision Engineering, 34(2): pp. 271-278; and (b) [6] Hopkins, J. B., 2007, “Design of Parallel Flexure Systems via Freedom and Constraint Topologies (FACT).” Masters Thesis. Massachusetts Institute of Technology.

### Actuation Space

Every flexure system uniquely links to an actuation space. Actuation space is a geometric shape that visually represents the region wherein linear actuators should be placed for actuating the flexure system's DOFs with no/minimal parasitic error. Actuation spaces consist of actuation lines. In this paper these lines are shown in blue because, similar to constraint lines, actuation lines represent forces along their axes and may, therefore, also be modeled using wrench vectors. If a flexure system possesses n DOFs, it will require n linear actuators to actuate all of its DOFs and will, therefore, consist of n independent wrench vectors that represent actuation lines. The wrench vectors that represent the actuation lines within an actuation space are always independent of the wrench vectors that represent the constraint lines within the constraint space that was used to generate the actuation space.

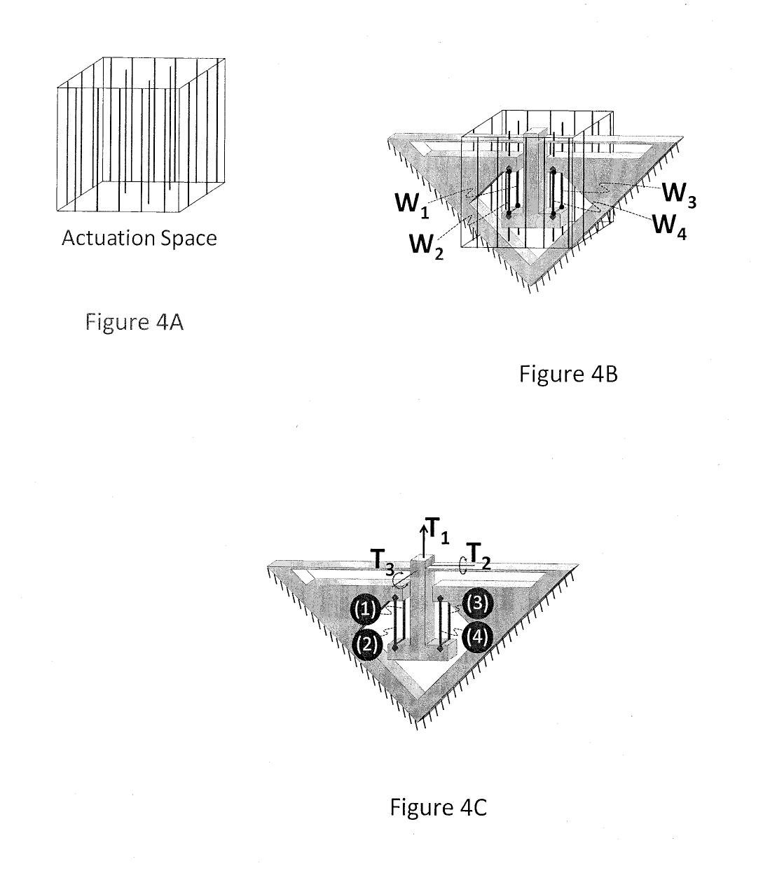

The actuation space of the flexure system from FIG. 2 is a box of infinite extent that contains every parallel actuation line that points in a direction normal to the plane of the flexure blades as shown in FIG. 4A. To actuate all three of the system's DOFs, only three linear actuators need to be aligned with three of the actuation lines within the box. To assure independence, these three actuators must not all lie on the same plane. Three such actuators are selected in FIG. 4B with a fourth redundant actuator for symmetry's sake. The four actuators are simple wire flexures, which apply forces along their axes when heated. If these wire flexures could be independently heated by running different amounts of current through them, the rectangular stage could be thermally actuated to move with any of the motions within the system's freedom space. If, for instance, the wire flexures labeled 2 and 4 in FIG. 4C were heated and the wire flexures labeled 1 and 3 were cooled, the stage would rotate about the rotational DOF modeled by twist T₂.

### Comprehensive Body of Geometric Shapes

There are a finite number of complementary freedom and constraint space pairs as well as a finite number of actuation spaces. All of these spaces are provided and derived in the incorporated Hopkins references. Using this comprehensive body of spaces, designers may consider every flexure system concept, which may be actuated to achieve any desired set of DOFs with minimal parasitic errors. The next section describes how these spaces may also be applied to the design of thermally actuated materials.

C. Synthesizing Thermally Actuated Materials

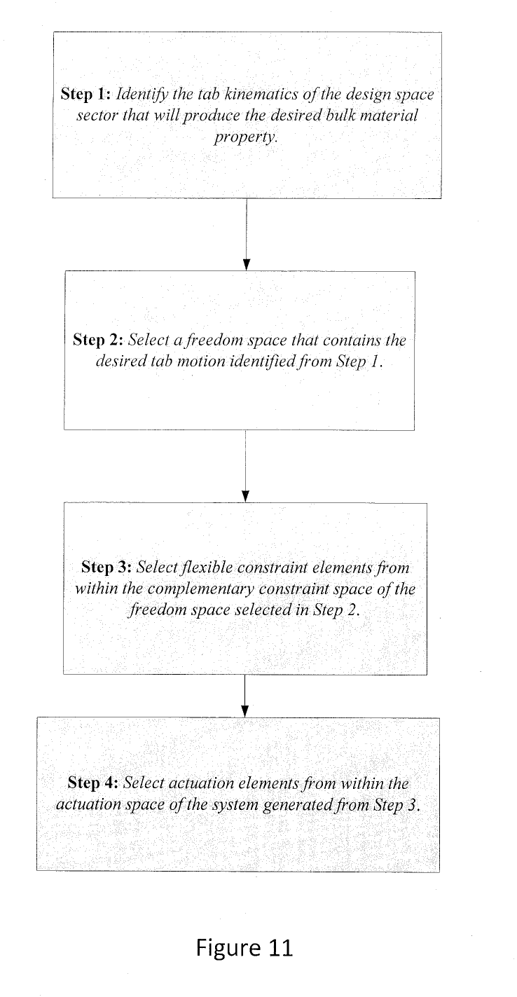

The synthesis approach of the present invention details for designing the microstructure of a material with any thermal expansion coefficient is shown in FIG. 11

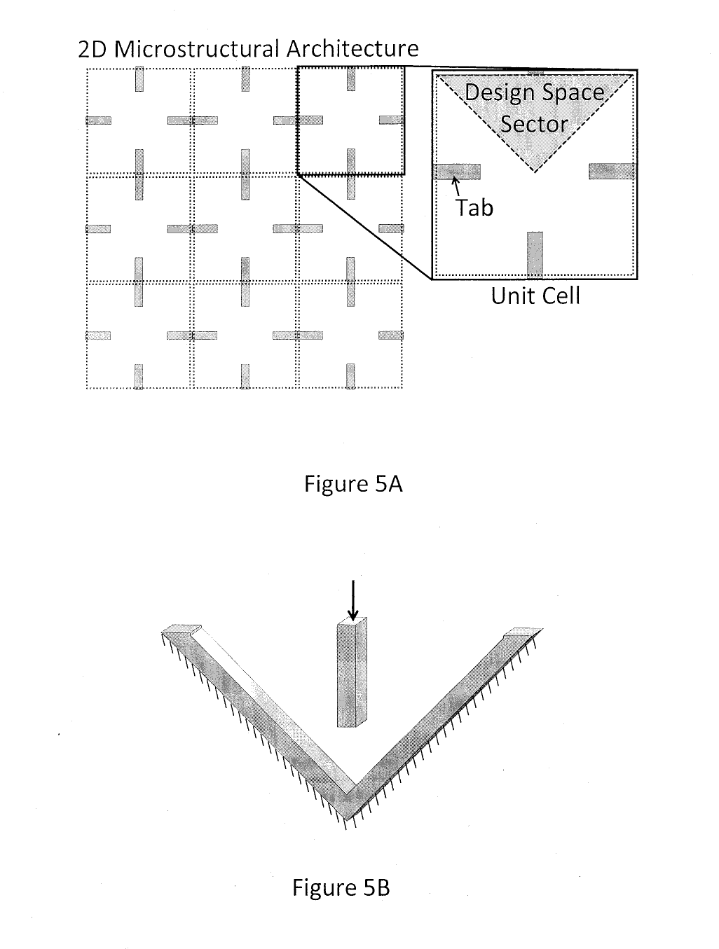

Considering the general 2D microstructural lattice of blank unit cells shown in FIG. 5A, every side of each cell possesses a tab, which connects to the tab of its neighboring cell. Each tab occupies a blank triangular sector, which represents the available design space for synthesizing microstructural elements that generate the desired tab response when subjected to a change in temperature. An example design space sector is shown highlighted in yellow in FIG. 5A. By coordinating the kinematic response of each tab within the bulk microstructural lattice, materials may be synthesized that possess a large variety of thermal properties. If, for instance, a designer wished to synthesize a material with a negative thermal expansion coefficient, he/she could apply the principles of FACT to consider every way flexible microstructural elements could be placed to connect the tab and v-shaped ground shown in the general design space sector of FIG. 5B such that the tab will pull inward when subjected to an increase in temperature. In this section, such negative-thermal-expansion-coefficient materials will be synthesized as case studies for demonstrating how FACT may be applied to the synthesis of thermally actuated material of all types.

There are two types of microstructural elements that are used to synthesize thermally actuated materials—flexure bearing elements, which guide the tab's kinematics, and actuation elements, which actuate the tab's kinematics. Constraint spaces are used to synthesize the flexure bearing elements and actuation spaces are used to synthesize the actuation elements. Recall the negative-thermal-expansion-coefficient microstructural architecture from FIG. 1B. The tab of its sector, shown in FIG. 1C, is designed to translate inward when subjected to an increase in temperature. The freedom space used to design the microstructural elements for this design, therefore, is the double-sided translation arrow shown in FIGS. 1C-D. The complementary constraint space of this freedom space is the set of all parallel planes, which are perpendicular to the direction of the translation arrow. The flexure bearing elements, which guide the tab to translate along the axis of the arrow, are flexure blades that are selected from two of the planes of the constraint space as shown in FIG. 1C. The axis of the actuation element shown in red is collinear with the line of the system's actuation space shown in FIGS. 1B-C.

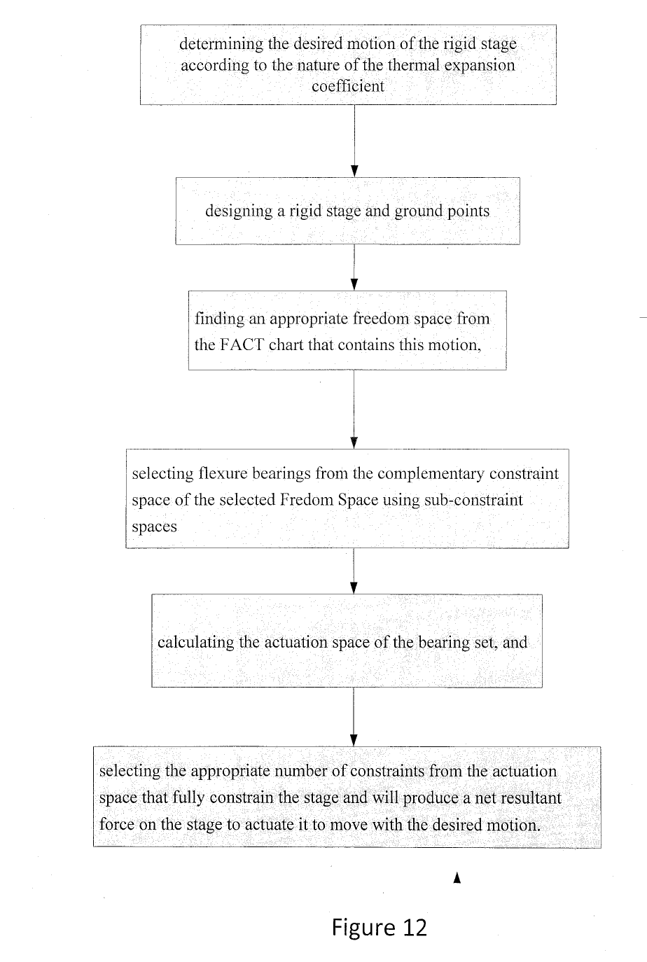

There are four systematic steps for synthesizing every microstructural concept of the present invention that achieves the desired tab kinematics given a change in temperature. These steps are outlined as follows and shown in FIG. 12:

Step 1: Identify the Tab Kinematics of the Design Space Sector that Will Produce the Desired Bulk Material Property.

According to screw theory, there are only three fundamental ways the tab could move when subjected to a change in temperature. The tab could either (i) rotate about a desired axis, (ii) translate in a desired direction, or (iii) translate while rotating along and about a desired screw axis with a coupled pitch value. Step 1, therefore, requires that the designer not only select the type of motion (i.e., rotation, translation, or screw) with which the tab should move, but also the location and orientation of that motion's axis. For materials with customized thermal expansion coefficients, the tab will always translate in the direction of the tab's axis as shown by the arrow in FIG. 5B.

Step 2: Select a Freedom Space that Contains the Desired Tab Motion Identified from Step 1.

This freedom space will represent the DOFs that the flexure bearing elements will permit the tab to possess. This freedom space could simply be the motion selected from Step 1, but it could also be any other freedom space that contains that motion from the comprehensive body of freedom spaces discussed in section 2.4. For the negative-thermal-expansion-coefficient example where the desired tab motion is a simple translation along the axis of the tab, the double-sided arrow was selected as the freedom space for the sector of FIG. 1C. For the sector of FIGS. 2-4, the freedom space selected was a plane of rotation lines with a translation arrow perpendicular to the plane as shown in FIG. 2D and FIG. 3A. There are twelve other freedom spaces from the comprehensive body of freedom spaces, which possess one or more translations that could have also been selected for generating other microstructural concepts, which would have also achieved a negative thermal expansion coefficient. To consider every microstructural solution, therefore, designers should also consider the concepts that lie within these other twelve freedom spaces. As a general rule, the less complex the selected freedom space is, the more practical the final microstructure design is likely to be.

Step 3: Select Flexible Constraint Elements from within the Complementary Constraint Space of the Freedom Space Selected in Step 2.

The flexible constraints selected must possess the necessary number of independent constraint lines, which pass through their geometry and connect the tab directly to ground. This necessary number of independent constraint lines may be determined using Eq. (1). Furthermore, the flexible constraints selected must act only as flexure bearings, which guide the tab with the motions of the freedom space, and not act as actuation elements, which displace the tab when subjected to changes in temperature. To insure the imperviousness of these constraint elements to changes in temperature, designers must make certain that every flexible constraint has a geometrically identical twin constraint on the other side of the tab through which constraint lines may pass directly from the ground of one constraint to the ground of the other constraint. In this way, when temperatures change, the thermal expansions of these flexible constraint elements will cancel and the tab will not be displaced. Consider the flexible constraints selected from the constraint space of FIG. 1C. The four flexure blades have been selected such that their thermal expansions or contractions will cancel when they are subjected to a change in temperature. Consider the flexible constraints selected from the constraint space of FIG. 3B. The two flexure blades have been selected such that their thermal expansions and contractions cancel as well. In both of these examples, the flexible constraint elements act only as bearings that guide the motions of the freedom space.

Step 4: Select Actuation Elements from within the Actuation Space of the System Generated from Step 3.

Once the flexible constraint elements have been selected from the constraint space of the freedom space of Step 2, the system's actuation space may be determined using the principles provided in the incorporated Hopkins references. Once this actuation space is known, the designer may select actuation elements from within that space. The actuation elements selected must possess the necessary number of independent actuation lines, which pass through their geometry and connect the tab directly to ground. The necessary number of independent actuation lines is the number of DOFs, n, within the freedom space selected in Step 2. Note that once the tab is constrained by both the necessary number of independent actuation lines, n, from the actuation elements, and the necessary number of independent constraint lines, 6-n, from the flexure bearing elements, the total number of independent wrenches that constrain the system from both types of microstructural elements is six. This means that the tab is fully constrained and that the system has become a structure with no DOFs. Recall that the tabs from both sector examples in FIG. 1C and FIG. 4C are fully constrained in this way. If their actuation elements shown in red possess a larger thermal expansion coefficient than their flexure bearing elements shown in grey, the tabs will pull inward and the intended translational DOF identified in Step 1 will be actuated when heat is applied.

The method may alternatively be characterized as follows, as shown in FIG. 13. First, a rigid stage and ground points are designed. Then the desired motion of the rigid stage according to the nature of the thermal expansion coefficient is determined. Then an appropriate freedom space from the FACT chart that contains this motion is determined. Next flexure bearings are selected from the complementary constraint space of the selected Freedom Space using sub-constraint spaces. And the actuation space of the bearing set is calculated. And finally, the appropriate number of constraints is selected from the actuation space that fully constrain the stage and will produce a net resultant force on the stage to actuate it to move with the desired motion.

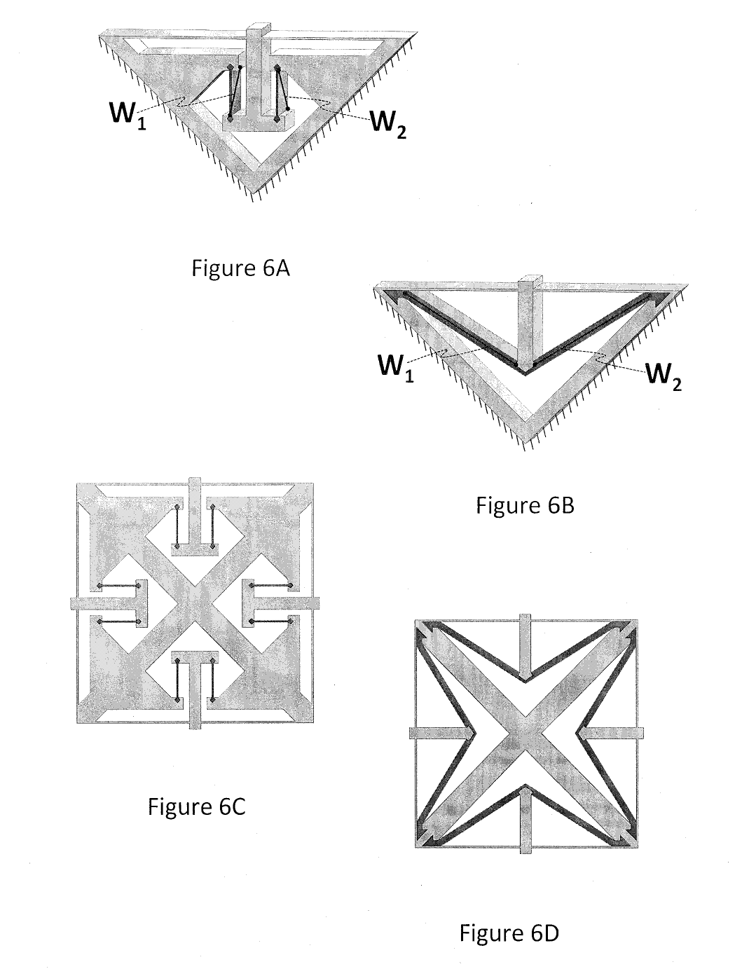

It is also important to note that not every actuation element must possess actuation lines that lie within the system's actuation space. As long as (i) the wrench vector, which describes the resultant force of the heated actuation elements, lies within the actuation space and (ii) the actuation elements selected possess the necessary number of independent actuation lines, microstructural concepts may be generated that possess the desired thermal properties. Consider, for example, the two negative-thermal-expansion sectors shown in FIGS. 6A-B. Both concepts are constrained by the same two flexure bearing elements used in the example from FIGS. 2-3. The actuation space for both systems is, therefore, the same actuation space as the one shown in FIG. 4A. Note, however, that both concepts from FIG. 6A-B possess actuation lines, which pass through the geometry of the actuation elements, but do not lie within the system's actuation space. Examples of such actuation lines are shown labeled as wrenches in the figures. The reason that these concepts produce the desired tab kinematics when heated is that the resultant forces of the expanding elements from both concepts both lie within the actuation space of FIG. 4A. The unit cells of these concepts are shown in FIGS. 6C-D.

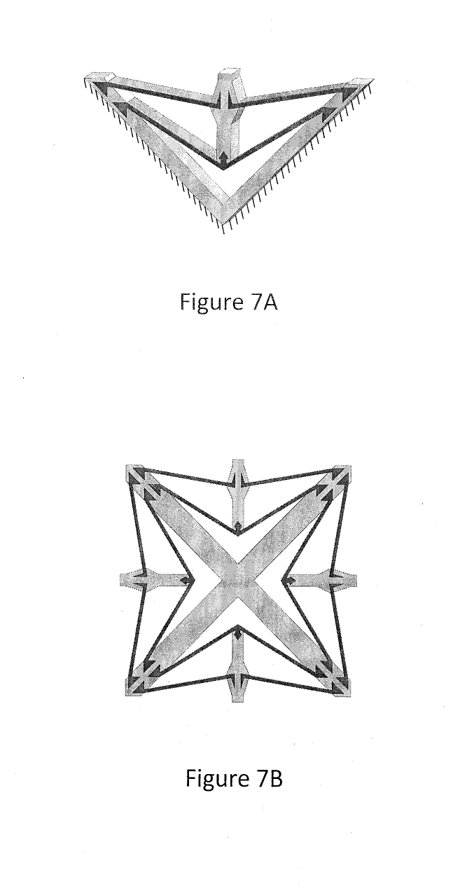

Finally, it is important to realize that not every concept requires flexure bearing elements to guide the tab. As long as (i) the wrench vector, which describes the resultant force of the heated actuation elements, produces the desired tab kinematics and (ii) the actuation elements selected possess the six necessary independent actuation lines to produce a structure, microstructural concepts may be generated that possess the desired thermal properties. Consider, for instance, the sector example shown in FIG. 7A. This concept possesses no flexure bearing elements or DOFs but when heated, its tab will be pulled downward. Its unit cell is shown in FIG. 7B. From a design standpoint, this type of microstructural architecture has problems because its actuator elements are doing the job of the bearings while also fighting against each other to actuate the tab's motions.

Once FACT has been used to generate and consider every microstructural concept for achieving a desired thermal property, the most practical of the concepts may be compared to determine the design that best satisfies the functional requirements. The concept from FIG. 1B doesn't possess as high a degree of symmetry as the other concepts. The concept of FIG. 4C isn't planar and would, therefore, be more difficult to fabricate. The parameters of the concepts from FIG. 1B and FIG. 6C couldn't be easily changed to achieve positive, zero, and negative thermal expansion coefficients. The most promising concept generated in this paper, therefore, is the concept from FIG. 6D. As the length of its tab changes such that the tip of the triangle formed by the adjoining actuation elements gets closer or farther from to the plane of the flexure bearing elements, the concept can be made to possess negative, zero, and positive thermal expansion coefficients. The flexure bearing elements and the actuator elements make the best use of the area within the triangular sector for achieving the largest range of thermal expansion coefficients. In a later paper it will be shown that this concept is also capable of achieving high stiffness characteristics.

D. Analyzing Thermally Actuated Materials

Once designers have successfully used FACT to synthesize the topologies of thermally actuated microstructural architectures, they must then use a different but complementary tool to analyze and optimize the performance of these architectures. This section provides the theory necessary to create such a tool for analytically calculating the responses of thermally actuated materials that have been designed using FACT. The theory for this tool is similar to traditional matrix-based finite-element approaches, but the mathematics have been formulated to be compatible with twist and wrench vectors making this analysis tool compatible with the mathematics of FACT.

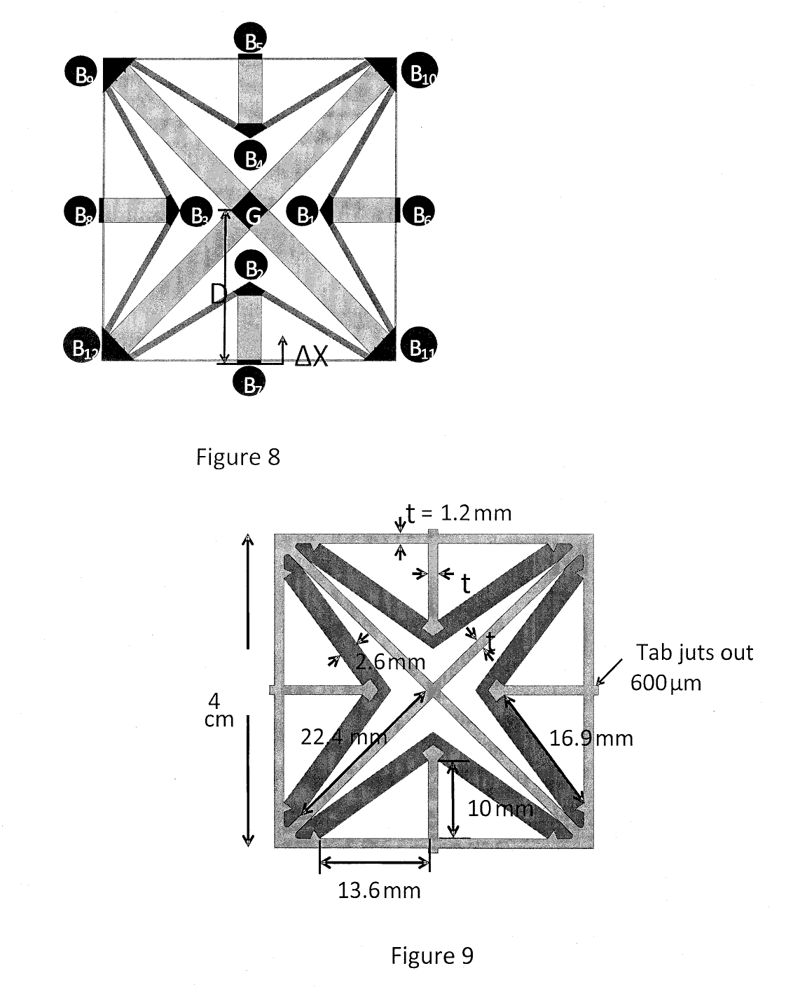

Suppose we wished to calculate the thermal expansion coefficient, α, of a bulk material, which consisted of many copies of the unit cell from FIG. 6D shown again in FIG. 8. We would need to calculate how much the tab labeled B₇ in FIG. 8 displaces inward, ΔX, when subjected to a change in temperature, ΔT, by applying the following equation

$$α = - \frac{Δ X \text{/} D}{Δ T} , \qquad ( 2 )$$

where D is the distance from the center of the unit cell to the edge of its tab as shown in the figure. Note that the center of the unit cell is labeled G because it is grounded or held fixed as the cell is subjected to changes in temperature.

To analytically calculate ΔX, we should first model the unit cell as a series of small rigid bodies, which are connected together by flexible elements. In FIG. 8 the 13 rigid bodies of this unit cell are shown in black and are labeled B₁ through B₁₂ with the central rigid body labeled G because it is grounded. The red and grey elements are modeled as flexure blades where the width of the blades is how deep the unit cell extends into the figure. Second, we should calculate the displacement twist vector, T₇, of the rigid body labeled B₇ in FIG. 8 that results from applying a change in temperature, ΔT, to the entire unit cell according to:

[T₁ T₂ . . . T_{R}]^{T}=[K]⁻¹·([W₁ W₂ . . . W_{R}]^{T}−A·ΔT), (3)

where T_{b} is the 1×6 displacement twist vector that pertains to the displacement of the rigid body labeled B_{b} in FIG. 8, R is the number of rigid bodies that are not grounded (R=12 for this example), [K] is the unit cell's (6*R)×(6*R) general stiffness matrix, W_{b} is the 1×6 wrench vector that pertains to the force/moment load imposed on the rigid body labeled B_{b}, and A is the unit cell's (6*R)×1 general thermal vector. For this example, the wrench vectors W₁ through W₁₂ in Eq. (3) are all zero vectors because no mechanical loads need to be imposed on any of the rigid bodies to determine the unit cell's thermal expansion coefficient. Once T₇ is calculated, the displacement, ΔX, of the rigid body labeled B₇ may be determined from the definition of a twist vector. The derivation of Eq. (3) along with the details for how to construct the [K] matrix and the A vector for any unit cell is the topic of the next section.

### Analysis Tool Derivation and Theory

This section provides the mathematics for constructing Eq. (3) for any general microstructural architecture. This equation may be used to rapidly analyze the displacement responses of all the rigid bodies interconnected by flexible elements within the microstructure when subjected to changes in temperature or loaded with various forces or moments. The mathematics for constructing this equation is not intended to be executed by hand, but rather using a program written in a language intended for rapid matrix manipulation (e.g., MATLAB). This section provides the theory necessary to write such a code.

Analysis:

Details and pictures on our approach for analyzing any material's microstructure are also provided in the attached power point. The equations used are pasted below. Their parameters are defined in FIG. 1. These equations are the key for determining how every rigid stage responds to forces, moments, and temperature loads for systems where the rigid stages are connected by various flexible elements. This code is used to calculate any microstructure's material properties.

This section provides the mathematics for constructing Eq. (3) for any general microstructural architecture. This equation may be used to rapidly analyze the displacement responses of all the rigid bodies interconnected by flexible elements within the microstructure when subjected to changes in temperature or loaded with various forces or moments. The mathematics for constructing this equation is not intended to be executed by hand, but rather using a program written in a language intended for rapid matrix manipulation (e.g., MATLAB). This section provides the theory necessary to write such a code.

An overview of the approach for constructing Eq. (3) for a general microstructural architecture is to first assume that the displacement twist vectors for all the rigid bodies within the structure are already known. Then calculate the wrench vector loads on all of these rigid bodies by summing together the individual reaction wrench vectors imposed on each body by their surrounding flexible elements, which are deformed according to the known twist displacements of the bodies.

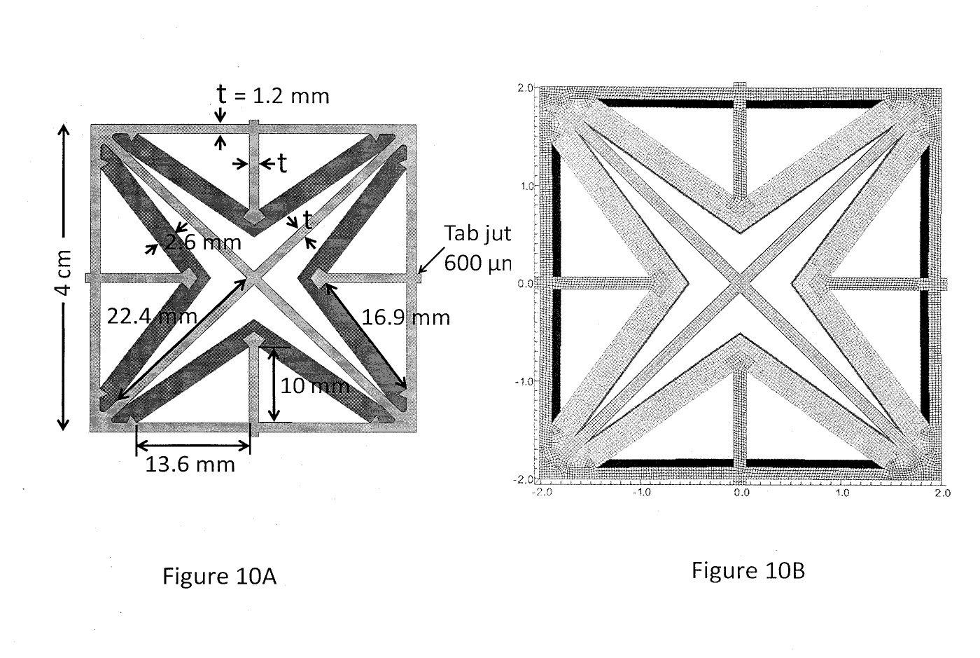

Consider, for instance, the general microstructural architecture shown in FIG. 9. This architecture consists of a single rigid ground and three rigid bodies interconnected by flexible elements of various geometries. Suppose we already know the twist displacement vectors, T₁, T₂, and T₃, of the three corresponding rigid bodies labeled B₁, B₂, and B₃ that result from loading these bodies with wrench vectors, W₁, W₂, and W₃, and heating up the entire structure by a temperature change of ΔT. Using these rigid body twist vectors, we could determine the deformation vectors, D^{(c)}, of every flexible element labeled (c). These 6×1 vectors fully describe element (c)'s deformations as

D^{(c)}=[₁Δθ^{(c)} ₂Δθ^{(c)} ₃Δθ^{(c)} ₁Δδ^{(c)} ₂Δδ^{(c)} ₃Δδ^{(c)}]^{T}, (4)

where ₁Δθ^{(c)} and ₂Δθ^{(c)} are the number of radians that element (c) is bent about orthogonal axes that are perpendicular to the axis of the element, ₃Δθ^{(c)} is the number of radians that the element is twisted about its axis, ₁Δδ^{(c)} and ₂Δδ^{(c)} are the transverse deformations of the element in the directions along the bending axes of ₁Δθ^{(c)} and ₂Δθ^{(c)} respectively, and ₃Δδ^{(c)} is the element's axial deformation.

Suppose we wished to determine the components of Eq. (4) for the deformation vector D⁽⁴⁾ that pertains to the flexible element labeled (4) in FIG. 9. Using our assumed knowledge of T₂ and T₃, we could calculate D⁽⁴⁾ by comparing the six orthogonal rotations and translations of the two points at each end of constraint (4) according to

D⁽⁴⁾=[N_{2,2}^{(f)]}⁻·T₂^{T}−([I_{6×6}]−[P⁽⁴⁾])·[N_{3,2}^{(f)]}⁻¹·T₃^{T}, (5)

where [N_{2,2}⁽⁴⁾] and [N_{3,2}⁽⁴⁾] are 6×6 matrices defined by

$$[ {N}_{b , d}^{( c )} ] = [ \begin{matrix}{}_{1}^{ }{n}{}_{b , d}^{( c )} & {}_{2}^{ }{n}{}_{b , d}^{( c )} & {}_{3}^{ }{n}{}_{b , d}^{( c )} & {0}_{3 \times 1} & {0}_{3 \times 1} & {0}_{3 \times 1} \\ {L}_{b}^{( c )} \times {}_{1}^{ }{n}{}_{b , d}^{( c )} & {L}_{b}^{( c )} \times {}_{2}^{ }{n}{}_{b , d}^{( c )} & {L}_{b}^{( c )} \times {}_{3}^{ }{n}{}_{b , d}^{( c )} & {}_{1}^{ }{n}{}_{b , d}^{( c )} & {}_{2}^{ }{n}{}_{b , d}^{( c )} & {}_{3}^{ }{n}{}_{b , d}^{( c )}\end{matrix} ] , \qquad ( 6 )$$

where L_{b}^{(c)} is a 3×1 vector that points from the microstructural architecture's arbitrarily selected coordinate system to the central point where flexible element (c) attaches to rigid body B_{b} according to the labeling convention shown in FIG. 9. The vectors ₁n_{b,d}^{(c)} and ₂n_{b,d}^{(c)} are orthogonal 3×1 unit vectors that point in directions along the bending axes of ₁Δθ^{(c)} and ₂Δθ^{(c)} from Eq. (4) and correspond with the transverse principle stiffness directions of flexible element (c). The vector ₃n_{b,d}^{(c)} is also a 3×1 unit vector, but it points in the direction along the axis of element (c). This vector is the cross product of ₁n_{b,d}^{(c)} and ₂n_{b,d}^{(c)}. The subscript d determines the direction of vector ₃n_{b,d}^{(c)} in that d corresponds to which rigid body the vector points into along element (c)'s axis. If the vector ₃n_{3,d}⁽⁴⁾, for instance, pointed into rigid body, B₂, along element (4)'s axis as it does in FIG. 9, d would be 2. It is also important to note that the [N_{2,d}⁽⁴⁾] and [N_{3,d}⁽⁴⁾] matrices in Eq. (5) must have equivalent d values (i.e., d=2 for this example) because the unit vectors that point along the axes of constraint (4), ₃n_{2,2}⁽⁴⁾ and ₃n_{3,2}⁽⁴⁾, must point in the same direction as shown in FIG. 9. Furthermore, the transverse unit vectors ₁n_{2,2}⁽⁴⁾ and ₂n_{2,2}⁽⁴⁾ within matrix [N_{2,2}⁽⁴⁾] and the transverse unit vectors ₁n_{3,2}⁽⁴⁾ and ₂n_{3,2}(⁴⁹ within matrix [N_{3,2}⁽⁴⁾] must also point in corresponding directions as shown in FIG. 9. As long as these conditions are satisfied, the calculations of this method are not affected by the directions in which the unit vectors are chosen to point. For more detail on the meaning and derivation of Eq. (6) see Hopkins [7,35]. The vector 0_{3×1} from Eq. (6) is a vector of zeros. The matrix [I_{6×6}] from Eq. (5) is an identity matrix and the matrix [P⁽⁴⁾] is defined by

$$[ {P}^{( c )} ] = [ \begin{matrix}[ {0}_{3 \times 3} ] & [ {0}_{3 \times 3} ] \\ [ \begin{matrix}0 & - l & 0 \\ l & 0 & 0 \\ 0 & 0 & 0\end{matrix} ] & [ {0}_{3 \times 3} ]\end{matrix} ] , \qquad ( 7 )$$

where l is the length of the flexible element (c) and [0_{3×3}] is a matrix of zeros.

Now that the deformation vector, D⁽⁴⁾, of flexible element (4) is known as a function of the displacement twist vectors, T₂ and T₃, of the rigid bodies that the element spans according to Eq. (5), we can calculate the element's 6×1 reaction moment and force vector, M⁽⁴⁾, due to the element's deformation and change in temperature, ΔT, as

M⁽⁴⁾=[S⁽⁴⁾]·D⁽⁴⁾+E⁽⁴⁾·ΔT, (8)

where

M^{(c)}=[Γ^{(c)} ₂Γ^{(c)} ₃Γ^{(c)} ₁f^{(c)} ₂f^{(c)} ₃f^{(c)}]^{T}, (9)

and ₁Γ^{(c)} and ₂Γ^{(c)} are the scalar reaction moments of the deformed flexible element (c) about the bending axes of ₁Δθ^{(c)} and ₂Δθ^{(c)} from Eq. (4) respectively, ₃Γ^{(c)} is the scalar torsion moment about the axis of element (c), ₁f^{(c)} and ₂f^{(c)} are the scalar transverse forces along the same bending axes of ₁Δθ^{(c)} and ₂Δθ^{(c)} from Eq. (4) respectively, and ₃f^{(c)} is the scalar reaction force along the axis of element (c). The 6×6 matrix [S⁽⁴⁾] from Eq. (8) is defined by

$$[ {S}^{( c )} ] = {[ \begin{matrix}\frac{l}{{EI}_{1}} & 0 & 0 & 0 & - \frac{{l}^{2}}{2 {EI}_{1}} & 0 \\ 0 & \frac{l}{{EI}_{2}} & 0 & \frac{{l}^{2}}{2 {EI}_{2}} & 0 & 0 \\ 0 & 0 & \frac{l}{GJ} & 0 & 0 & 0 \\ 0 & \frac{{l}^{2}}{2 {EI}_{2}} & 0 & \frac{{l}^{3}}{3 {EI}_{2}} & 0 & 0 \\ - \frac{{l}^{2}}{2 {EI}_{1}} & 0 & 0 & 0 & \frac{{l}^{3}}{3 {EI}_{1}} & 0 \\ 0 & 0 & 0 & 0 & 0 & \frac{l}{EA}\end{matrix} ]}^{- 1} , \qquad ( 10 )$$

where E is the modulus of elasticity of flexible element (c), G is the element's shear modulus, I₁ and I₂ are the element's bending moments of inertia about the bending axes of ₁Δθ^{(c)} and ₂Δθ^{(c)} from Eq. (4) respectively, J is the element's polar moment of inertia, A is the element's cross sectional area, and l is the element's length. The 6×1 vector E⁽⁴⁾ from Eq. (8) is defined by

E^{(c)}=[0 0 0 0 0 −EAα]^{T}, (11)

where E is the modulus of elasticity of flexible element (c), A is the element's cross-sectional area, and α is the element's thermal expansion coefficient. Note that although the definitions of [S^{(c)}] from Eq. (10) and E^{(c)} from Eq. (11) are applicable only for wire or other slender beam-like blade flexures with constant cross-sectional areas that are made of homogenous, isotropic, linear elastic materials, these equations are not applicable for other obscure flexible element geometries such as living hinges, plates, or other curved blade flexures. The appropriate stiffness expressions within the matrix [S^{(c)}] and the appropriate component within the vector E^{(c)} must, therefore, be identified in order to analyze microstructural architectures with other obscure flexible element geometries.

Now that the reaction moment and force vector, M⁽⁴⁾, has been determined using Eq. (8), the 1×6 reaction wrench vector, W₂⁽⁴⁾, caused by the deformed flexible element (4) imposed on rigid body B₂ labeled in FIG. 9 may be calculated according to

W₂⁽⁴⁾^{⁷}=[NR_{2,2}⁽⁴⁾]·M⁽⁴⁾, (12)

where the 6×6 matrix [NR_{2,2}⁽⁴⁾] is defined by

$$[ {NR}_{b , d}^{( c )} ] = [ \begin{matrix}{0}_{3 \times 1} & {0}_{3 \times 1} & {0}_{3 \times 1} & {}_{1}^{ }{n}{}_{b , d}^{( c )} & {}_{2}^{ }{n}{}_{b , d}^{( c )} & {}_{3}^{ }{n}{}_{b , d}^{( c )} \\ {}_{1}^{ }{n}{}_{b , d}^{( c )} & {}_{2}^{ }{n}{}_{b , d}^{( c )} & {}_{3}^{ }{n}{}_{b , d}^{( c )} & {L}_{b}^{( c )} \times {}_{1}^{ }{n}{}_{b , d}^{( c )} & {L}_{b}^{( c )} \times {}_{2}^{ }{n}{}_{b , d}^{( c )} & {L}_{b}^{( c )} \times {}_{3}^{ }{n}{}_{b , d}^{( c )}\end{matrix} ] , \qquad ( 13 )$$

where the components within [NR_{b,d}^{(c)}] are the same as those within [N_{b,d}^{(c)}] from Eq. (6) but are arranged differently. It is important to note that the ₃n_{2,2}⁽⁴⁾ and ₃n_{3,2}⁽⁴⁾ vectors within Eqs. (5-6) and (12-13) should both point into rigid body B₂ if the wrench vector W₂⁽⁴⁾ imposed on rigid body B₂ is being calculated as shown in FIG. 9.
If we wished now to calculate the 1×6 wrench vector load, W₂, imposed on rigid body B₂ labeled in FIG. 9, we should first use the previous equations to calculate the other 1×6 reaction wrench vectors, W₂⁽²⁾, W₂⁽⁵⁾, and W₂⁽⁶⁾, imposed on rigid body B₂ by its surrounding deformed flexible elements, (2), (5), and (6), respectively. We should then sum these vectors together according to

W₂=W₂⁽²⁾+W₂⁽⁴⁾+W₂⁽⁵⁾+W₂⁽⁶⁾. (14)

To relate W₂ to the previously assumed displacement twist vectors, T₁, T₂, and T₃, of the three corresponding rigid bodies labeled B₁, B₂, and B₃ in FIG. 9 and the change in temperature, ΔT, imposed on the entire microstructural architecture, we could combine the previously defined equations of this section according to

W₂^{T}=[K₂]·[T₁ T₂ T₃]^{T}+A₂·ΔT, (15)

where [K₂] is a 6×(6*R) matrix (recall that R is the number of rigid bodies that are not grounded in the microstructural architecture, which for the structure shown in FIG. 9 equals 3) that pertains to rigid body B₂ and is defined by

$$\begin{matrix}[ {K}_{2} ] = {[}^{4} Δ ] \cdot [ \begin{matrix}[ {C}^{( 2 )} ] \\ [ {C}^{( 4 )} ] \\ [ {C}^{( 5 )} ] \\ [ {C}^{( 6 )} ]\end{matrix} ] , \\ where & ( 16 ) \\ {[}^{s} Δ ] = [ [ {I}_{6 \times 6} ] [ {I}_{6 \times 6} ] ⋯ [ {I}_{6 \times 6} ] ] , & ( 17 )\end{matrix}$$

and s corresponds to the number of flexible elements that surround the rigid body of interest. Parameter s is also the number of identity matrices, [I_{6×6}], that populate the 6×(6*s) matrix [^{s}Δ]. The 6×(6*R) matrices [C⁽²⁾], [C⁽⁴⁾], [C⁽⁵⁾], and [C⁽⁶⁾] from Eq. (16) each correspond to one of the flexible elements (c) surrounding rigid body B₂ from FIG. 9 and are defined by

[C⁽²⁾]=[[0_{6×6}] [NR_{2,2}⁽²⁾]·[S⁽²⁾]·[N_{2,2}⁽²⁾]⁻¹ −[NR_{2,2}⁽²⁾]·[S⁽²⁾]·([I_{6×6}]−[P⁽²⁾])·[N_{3,2}⁽²⁾]⁻¹], (18)

[C⁽⁴⁾]=[[0_{6×6}] [NR_{2,2}⁽⁴⁾]·[S⁽⁴⁾]·[N_{2,2}⁽⁴⁾]⁻¹ −[NR_{2,2}⁽⁴⁾]·[S⁽⁴⁾]·([I_{6×6}]−[P⁽⁴⁾])·[N_{3,2}⁽⁴⁾]⁻¹], (19)

[C⁽⁵⁾]=[[0_{6×6}] [NR_{2,2}⁽⁵⁾]·[S⁽⁵⁾]·[N_{2,2}^{(5)]}⁻¹ [0_{6×6}]], (20)

and

[C⁽⁶⁾]=[−[NR_{2,2}⁽⁶⁾]·[S⁽⁶⁾]·([I_{6×6}]−[P⁽⁶⁾])·[N_{1,2}⁽⁶⁾]⁻¹ [NR_{2,2}⁽⁶⁾]·[S⁽⁶⁾]·[N_{2,2}⁽⁶⁾]⁻¹ [0_{6×6}]]. (21)

The 6×1 vector A₂ from Eq. (15) is defined as

$${A}_{2} = {[}^{4} Δ ] \cdot [ \begin{matrix}[ {NR}_{2 , 2}^{( 2 )} ] \cdot {E}^{( 2 )} \\ [ {NR}_{2 , 2}^{( 4 )} ] \cdot {E}^{( 4 )} \\ [ {NR}_{2 , 2}^{( 5 )} ] \cdot {E}^{( 5 )} \\ [ {NR}_{2 , 2}^{( 6 )} ] \cdot {E}^{( 6 )}\end{matrix} ] , \qquad ( 22 )$$

where all of its components have been defined previously in Eqs. (11), (13), and (17). Both vector A₂'s and matrix [K₂]'s subscripts from Eq. (15) refer to the rigid body of interest, which is B₂.
If we now wished to relate all of the wrench load vectors, W₁, W₂, and W₃, imposed on each rigid body, B₁, B₂, and B₃, within the microstructural architecture shown in FIG. 9, to the resulting displacement twist vectors, T₁, T₂, and T₃, of these rigid bodies subject to a change in temperature, ΔT, we could apply Eq. (15) to every rigid body such that

[W₁ W₂ W₃]^{T}=[K]·[T₁ T₂ T₃]^{T}+A·ΔT, (23)

where the (6*R)×(6*R) stiffness matrix [K] is defined by

$$[ K ] = [ \begin{matrix}[ {K}_{1} ] \\ [ {K}_{2} ] \\ [ {K}_{3} ]\end{matrix} ] , \qquad ( 24 )$$

where [K₂] is defined in Eq. (16) and [K₁] and [K₃] may each be calculated using the principles of Eq. (16) applied to the flexible elements that surround their respective rigid bodies B₁ and B₃. The (6*R)×1 thermal vector A from Eq. (23) is defined by

A=[A₁^{T} A₂^{T} A₃^{T}]^{T}, (25)

where A₂ is defined in Eq. (22) and the 6×1 vectors A₁ and A₃ may each be calculated using the principles of Eq. (22) applied to the flexible elements that surround their respective rigid bodies B₁ and B₃.
Finally note that Eq. (3) may be constructed by reorganizing Eq. (23). We have thus completed our discussion of how the general stiffness matrix [K] and thermal vector A of Eq. (3) may be constructed for any microstructural architecture.

### Verifying the Analysis Tool Using FEA

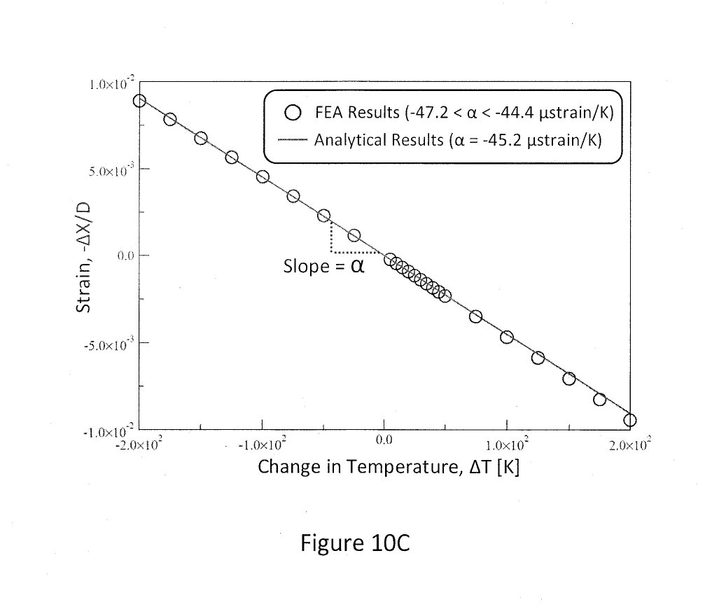

To verify the accuracy of the analytical tool that rapidly calculates the thermal response of a bulk material that consists of FACT-designed unit cells, an FEA software package called ALE3D was applied to the analysis of the microstructural concept shown labeled with its parameters in FIG. 10A. A mesh of the concept generated using ALE3D is shown in FIG. 10.B. The strain experienced by the unit cell for various changes in temperature was calculated using both ALE3D and the analytical theory of the previous section. These results are shown plotted in FIG. 10C. According to Eq. (2), the slope of the trend line, which passes through the data points, is the material's thermal expansion coefficient. According to the analytical theory of the previous section, the thermal expansion coefficient of the unit cell of FIG. 10A is −45.2 p strain/K. These results are within 1.3% error of the FEA results calculated. This error is largely due to the fact the analytical theory assumes that the rigid bodies shown in black in FIG. 8 are not only infinitely stiff but also have a thermal expansion coefficient of zero. It is clear from the small error observed, however, that these assumptions are reasonable as long as the rigid bodies are small compared to the flexible elements that connect them.

In the present invention the principles of the FACT synthesis approach and have applied to the design, analysis, and optimization of thermally actuated materials. The systematic process for selecting the various types of microstructural elements (i.e., flexure bearings and actuators) from within the geometric shapes of FACT have been provided and discussed in detail in the context of a number of case studies where various microstructural concepts with negative thermal expansion coefficients were synthesized. The mathematical tools that are necessary to calculate and optimize the thermal response of such microstructural architectures have also been provided and verified using ALE3D.

Although the description above contains many details and specifics, these should not be construed as limiting the scope of the invention or of what may be claimed, but as merely providing illustrations of some of the presently preferred embodiments of this invention. Other implementations, enhancements and variations can be made based on what is described and illustrated in this patent document. The features of the embodiments described herein may be combined in all possible combinations of methods, apparatus, modules, systems, and computer program products. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments.

Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present invention, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.”

We claim:

1. A method of synthesizing and analyzing the microstructure of a material with a desired thermal expansion coefficient comprising:
identifying tab kinematics of a design space sector that will produce a desired bulk material property;
selecting a freedom space that contains a desired tab motion identified from the tab kinematics identified;
selecting flexible constraint elements from within a complementary constraint space of the freedom space selected; and
selecting actuation elements from within an actuation space generated from a system generated from the flexible constraint element selection.

2. A method of synthesizing and analyzing the microstructure of a material with a desired thermal expansion coefficient comprising:
designing a rigid stage and ground points;
determining the desired motion of the rigid stage according to the nature of the thermal expansion coefficient;
determining an appropriate freedom space from the FACT chart that contains this motion;
selecting flexure bearings from the complementary constraint space of the selected Freedom Space using sub-constraint spaces;
calculating the actuation space of the bearing set; and
selecting the appropriate number of constraints from the actuation space that fully constrain the stage and will produce a net resultant force on the stage to actuate it to move with the desired motion.
